(19) United States
(12) Patent Application Publication
(10) Pub. No.: US 2026/0286045 A1
(43) Pub. Date: Sep. 24, 2026

(54) TITANATE COMPOUNDS AS CATALYSTS IN A METHOD FOR PRODUCING POLYESTER

(71) Applicant: Equipolymers GmbH, Schkopau (DE)

(72) Inventors: Jens-Peter WIEGNER, Halle (DE); Olaf HEMPEL, Leipzig (DE); Matthias STOLP, Merseburg (DE); Roland ABEL, Leipzig (DE)

(21) Appl. No.: 19/473,632

(22) PCT Filed: Apr. 11, 2024
(86) PCT No.: PCT/EP2024/059826

§ 371 Date: Oct. 8, 2025

(30) Foreign Application Priority Data
Apr. 13, 2023 (WO) PCT/EP2023/059647

(51) Int. Cl. C08G 63/85; C01G 23/00; C08G 63/183

(52) U.S. Cl. CPC C08G 63/85; C01G 23/003; C01G 23/006; C08G 63/183; C01P 2004/61; C01P 2004/62

(57) ABSTRACT

The invention relates to a method for producing a polyester in a polycondensation reaction catalyzed by an aluminum titanate compound, a barium titanate compound, a calcium titanate compound, zinc titanate compound, or a mixture of these titanate compounds. The invention also relates to a composition comprising the aluminum titanate compound, the barium titanate compound, the calcium titanate compound, zinc titanate compound, or a mixture of these titanate compounds as a catalyst for producing a polyester in a polycondensation reaction. Further, the invention relates to the use of the aluminum titanate compound, the barium titanate compound, the calcium titanate compound, the zinc titanate compound, or a mixture of these titanate compounds as a heterogeneous polycondensation catalyst. The aluminum titanate compound, the barium titanate compound, the calcium titanate compound, the zinc titanate compound, or a mixture of these titanate compounds is a non-amorphous mixed oxide of aluminum oxide (and/or barium oxide, and/or calcium oxide, and/or zinc oxide) with titanium oxide. These titanate compounds were found to be excellent heterogeneous catalysts in polycondensation reactions for producing polyesters, such as polyethylene terephthalate.

### TECHNICAL FIELD OF THE INVENTION

The invention generally relates to a method for producing a polyester in a polycondensation reaction catalyzed by one or more titanate compounds selected from the group consisting of an aluminum titanate compound (AITi), a barium titanate compound (BaTi), a calcium titanate compound (CaTi) and a zinc titanate compound (ZnTi). The invention also relates to a composition comprising one or more of the titanate compounds as a catalyst for producing a polyester in a polycondensation reaction. Further, the invention relates to the use of one or more of the titanate compounds as a heterogeneous polycondensation catalyst.

### BACKGROUND

Polyesters such as, for example, polyethylene terephthalate (PET), polytrimethylene terephthalate (PTT), polyethylene furanoate (PEF), and polybutylene terephthalate (PBT), are a class of important industrial polymers. They are widely used in thermoplastic fibers, films, and molding applications.

In the manufacturing of high molecular weight acyclic polyesters, such as polyethylene terephthalate (PET), polyethylene furanoate (PEF), polybutylene terephthalate (PBT), polytrimethylene terephthalate (PTT), and polyethylene naphthalate (PEN), several main reactions take place.

The first main reaction is an esterification reaction. In this reaction a polyacid and a polyol are esterified to a monomer suitable for the following polycondensation reaction. During the esterification reaction, undesired by-products can be formed like 1,3-dioxolane, 2-methyl-1,3-dioxolane, 1,4-dioxane and vinyl alcohol. The latter tautomerizes to acetaldehyde.

The second main reaction is a polycondensation reaction. This reaction is important for molecular weight build-up of the polyester. The polycondensation reaction may include two phases, a melt phase and a solid-state phase (SSP).

The polycondensation reaction is generally catalyzed by a catalyst. But also, the esterification reaction can be catalyzed by a catalyst, preferably by the same catalyst used for the polycondensation reaction.

As a catalyst for both the esterification and polycondensation reaction often antimony (III) compounds are used. However, antimony-based catalysts are coming under increased environmental pressure and regulatory control, especially in food contact and fiber applications. Antimony based catalysts may also cause problems with grey discoloration. Tin compounds can also be used in the esterification and polycondensation reactions, although they have similar toxicity and regulatory concerns as antimony.

Titanium based catalysts, either alone or in combination with other compounds, have been described for use in the preparation of polyesters in U.S. Pat. Nos. 4,482,700, 4,131,601, 5,302,690, 5,744,571, 5,905,136, and in WO 97/45470. US Patent Publication 2005/0009687 describes the use of a titanium alkoxide catalyst for the polymerization of, in particular, cyclic esters. There has been some concern that titanium catalysts, if used in the esterification and polycondensation reactions, tend to hydrolyze on contact with water forming glycol insoluble oligomeric species, which lose catalytic activity, as described in US 2005/0215425. Esters and polyesters produced using certain titanium compounds as catalysts may also suffer from yellow discoloration, as described in U.S. Pat. Nos. 4,131,601 and 4,482,700.

In order to solve these problems, many studies regarding the substitution of antimony compounds in polyester polycondensation reactions using titanium compounds as catalysts have been made.

The document CN 102391490 A discloses a preparation method of a titanium based polyester catalyst modified by tributyl phosphate supported on activated carbon. The black colored powder with a low specific surface area is obtained by dissolving isopropyl titanate, tributyl phosphate, aluminum chloride and activated carbon in an organic solvent, such as ethylene glycol and by adding water. The molar ratio of aluminum chloride to titanate is 1:19. Said catalyst improves the catalytic performance and reduces the yellowing effect in the final product.

The patent application CN 103289069 A discloses an aluminum titanium composite catalyst for polyester polycondensation, which is intended to substitute existing antimony series catalyst used in the polyester industry. The catalyst is prepared by adding dissolved tetrabutyl titanate into a sodium aluminate solution. The obtained white powder has a mole ratio of titanium element to aluminum element from 1:2 to 20:1 and is free of heavy metal element compounds.

In the document US2002193555 (A1) the preparation and use of hydrolysates of titanium halides is described. The synthesized oxyhydrates of titanium are stabilized by adding basic components (ammonia, magnesium oxide).

There is a need for a catalyst system for the synthesis of polyesters, in particular PET and its copolyesters, having increased catalytic activity, no or only minimal effect on the properties of the polyesters, leading to polyesters having no or reduced yellow color and reduced toxicity concerns.

Therefore, it is an object of the present invention to provide a polycondensation catalyst for the manufacture of polyesters, the catalyst should have similar activity and leading to similar color properties of the polyesters compared to antimony-based catalyst systems used in the past, but with reduced toxicity and regulatory concerns.

It is also an object of the present invention to provide a catalyst that results in low byproduct formation, such as acetaldehyde, during the processing of polyesters, in particular PET, as compared to commonly used titanium alcoholate catalyst systems. An example of byproduct formation is the formation of acetaldehyde that is formed during resin production and regenerated during processing.

It is a further object of the present invention to provide a catalyst which allows to substitute antimony in polyester polycondensation reactions without having a negative impact on production process and/or final product properties.

Another object of the present invention is to provide a catalyst for polyester polycondensation reactions leading to similar reaction rates (melt phase and solid-state phase) compared to those of conventional antimony based catalysts.

It is further an object of the present invention to provide a method for producing a polyester comprising a catalyst, which allows to substitute at least a part of antimony of a polyester polycondensation catalyst composition having no or minimal negative impact on production process and final product properties.

### DETAILED DESCRIPTION

The above-mentioned objects have been reached by the present invention, namely by the provision of a composition for a polyester polycondensation reaction, comprising: one or more catalysts, wherein at least one of the catalysts is a titanate compound or a mixture of titanate compounds; and at least one polyacid and at least one polyol; wherein the titanate compound or the mixture of the titanate compounds is in a crystalline form.

The titanate compound is selected from the group consisting of an aluminum titanate compound, a barium titanate compound, a calcium titanate compound, and a zinc titanate compound. The mixture of titanate compounds is selected from the group consisting of:
a mixture of an aluminum titanate compound and a barium titanate compound,
a mixture of an aluminum titanate compound and a calcium titanate compound,
a mixture of an aluminum titanate compound and a zinc titanate compound,
a mixture of a barium titanate compound and a calcium titanate compound,
a mixture of a barium titanate compound and a zinc titanate compound,
a mixture of a calcium titanate compound and a zinc titanate compound,
a mixture of an aluminum titanate compound, a barium titanate compound and a calcium titanate compound,
a mixture of an aluminum titanate compound, a barium titanate compound and a zinc titanate compound,
a mixture of a barium titanate compound, a calcium titanate compound and a zinc titanate compound, and
a mixture of an aluminum titanate compound, a barium titanate compound, a calcium titanate compound, and a zinc titanate compound.

In general, the composition according to the invention can be used for producing a polyester. In a typically method for producing the polyester at least one polyacid and at least one polyol are esterified to produce a monomer, also called prepolymer, followed by polycondensing the monomer to form the polyester.

Suitable polyacids include terephthalic acid, isophthalic acid, cyclohexane dicarboxylic acid, naphthalene dicarboxylic acid; and long chain branching acids like trimesinic acid, trimellitic acid, and its anhydride. Terephthalic acid is the preferred polyacid.

Suitable polyols include ethylene glycol, cyclohexane dimethanol, 1,3-propanediol, 2,2-dimethylpropanediol, 1,4-butanediol, isosorbide; aromatic polyols such as resorcinol, hydroquinone; and long chain branching polyols such as trimethylolpropane, glycerol and pentaerythritol. Ethylene glycol is the preferred polyol.

Now, the advantage of using an aluminum titanate compound, a barium titanate compound, a calcium titanate compound and/or a zinc titanate compound versus conventional titanium compounds is that the latter are very sensitive to water, as they undergo hydrolysis leading to catalytically inactive titanium species. And water is produced as an unavoidable main product of the esterification and polycondensation reaction. Beneficially, the aluminum titanate compound, the barium titanate compound, the calcium titanate compound and/or the zinc titanate compound according to the invention are not sensitive to water. Thus, the claimed catalyst composition may further comprise water without the risk of the aluminum titanate compound, the barium titanate compound, the calcium titanate compound and/or the zinc titanate compound being deactivated or otherwise negatively affected by the water. This further leads to the benefit that the aluminum titanate compound, the barium titanate compound, the calcium titanate compound and/or the zinc titanate compound may be added directly to the reaction composition at the beginning of the polyester polycondensation process.

For the aluminum titanate compound, the barium titanate compound, the calcium titanate compound and/or the zinc titanate compound used according to the present invention it is decisive that the compound is in a crystalline form. “In a crystalline form” means here that the aluminum titanate compound, the barium titanate compound, the calcium titanate compound and/or the zinc titanate compound is not amorph but has at least a polycrystalline or paracrystalline structure. Polycrystalline or paracrystalline structures are typically characterized by a number of crystallites held together by layers of amorphous solid material of the compound.

It has been found by the inventors that if the aluminum titanate compound, the barium titanate compound, the calcium titanate compound and/or the zinc titanate compound is used in a crystalline form instead of using it in amorphous form it shows better catalytic performance.

It seems that the superior catalytic performance of crystalline aluminum titanate, barium titanate, calcium titanate or zinc titanate results from the titanium having only one free coordination site in the crystalline structure of the aluminum titanate, barium titanate, calcium titanate or zinc titanate. Without any free coordination site of the titanium atoms in a compound such compound would not be able to catalyze the polycondensation reactions at all. However, it is assumed that an aluminum titanate, a barium titanate, a calcium titanate and/or a zinc titanate compound in a structural form having more than one free coordination site at the titanium atoms, like in case of aluminum titanate, barium titanate, calcium titanate and/or zinc titanate in amorphous form, allows side reactions leading to undesired side products.

According to the invention it is preferred that the amount of the aluminum titanate compound, the barium titanate compound, the calcium titanate compound or the zinc titanate compound in a crystalline form in the composition is more than 10% by weight based on the total amount of the one or more catalysts. More preferably, the amount of the aluminum titanate compound, the barium titanate compound, the calcium titanate compound or the zinc titanate compound in a crystalline form is more than 50% by weight based on the total amount of the one or more catalysts. Most preferably, the amount of the aluminum titanate compound, the barium titanate compound, the calcium titanate compound or the zinc titanate compound in a crystalline form is more than 80% by weight, or even 100% by weight, based on the total amount of the one or more catalysts. In case of a mixture of two, three or four of the mentioned titanate compounds, the above given amounts in % by weight count for the mixture of the two, three or four titanate compounds.

According to the invention it is preferred that the amount of titanium in form of the aluminum titanate compound, the barium titanate, the calcium titanate compound and/or the zinc titanate compound in a crystalline form in the composition is from 1 ppm to 100 ppm by weight, preferably from 4 ppm to 50 ppm by weight, and more preferably from 8 ppm to 30 ppm by weight, based on the total weight of the sum of the at least one polyacid and the at least one polyol of the composition, or based on the polyester formed by the polyester polycondensation reaction.

The aluminum titanate compound, the barium titanate compound, the calcium titanate compound and/or the zinc titanate compound can but do/does not need to be in the form of pure crystals. Typically the aluminum titanate compound, the barium titanate compound, the calcium titanate compound and/or the zinc titanate compound is/are in a polycrystalline or paracrystalline form. Preferably, the aluminum titanate compound, the barium titanate compound, the calcium titanate compound and/or the zinc titanate compound used according to the invention has/have a crystallinity of at least 90% by weight, preferably at least 95% by weight, more preferably at least 98% by weight.

The aluminum titanate compound, the barium titanate compound, the calcium titanate compound and/or the zinc titanate compound used as catalyst in the composition according to the invention can be free of any rare earth elements. Also, the aluminum titanate compound, the barium titanate compound, the calcium titanate compound and/or the zinc titanate compound can be free of organic groups.

The same applies to the optional further catalysts which may be present in the composition according to the invention. Thus, catalysts comprising rare earth elements may be excluded from the one or more catalysts of the composition, and/or catalysts comprising organic groups, e.g. organometallic catalysts, may be excluded from the one or more catalysts of the composition.

According to the invention it is also preferred that the composition for the polyester polycondensation reaction is free of antimony compounds, especially is free of catalysts comprising antimony, or comprises only less amounts of antimony compounds, namely less than 200 ppm, and preferably less than 100 ppm antimony compounds.

The aluminum titanate compound, the barium titanate compound, the calcium titanate compound and/or the zinc titanate compound present in the composition according to the invention can be characterized to be a mixed oxide comprising aluminum oxide and/or barium oxide and/or calcium oxide and/or zinc oxide together with titanium dioxide. Optionally, water of crystallization may be present in said mixed oxide. In a preferred alternative, the aluminum titanate compound, the barium titanate compound or calcium titanate compound according to the invention consists of aluminum atoms, titanium atoms and oxygen atoms, or consists of barium atoms, titanium atoms and oxygen atoms, or consists of calcium atoms, titanium atoms and oxygen atoms, or consists of zinc atoms, titanium atoms and oxygen atoms. Optionally, water of crystallization may be additionally present. However, typically, the aluminum titanate compound, the barium titanate compound, the calcium titanate compound and/or the zinc titanate compound present in the composition according to the invention is characterized to be free of water of crystallization. It is preferred that the aluminum titanate compound, the barium titanate compound, the calcium titanate compound and/or the zinc titanate compound present in the composition according to the invention is a mixed oxide consisting of aluminum oxide and titanium dioxide, or consists of aluminum atoms, titanium atoms and oxygen atoms.

The aluminum titanate compound, the barium titanate compound, the calcium titanate compound and/or zinc titanate compound may be prepared via at least two different routes: 1.) a dry route including mixing crystalline oxides or carbonates of aluminum, barium, calcium or zinc titanium oxides, and 2.) a wet-chemical route including reacting a soluble aluminum, barium, calcium or zinc compound with a soluble titanium compound in a solvent.

According to the dry route the aluminum titanate compound is prepared by mixing a mixture comprising or consisting of crystalline Al₂O₃, e.g. corundum, and crystalline TiO₂, e.g. rutile, followed by sintering the mixture. Optionally, and to have smaller average primary particle diameters of the crystalline oxides prior to sintering, the crystalline Al₂O₃ and/or the crystalline TiO₂ may be grinded prior to the mixing step or prior to the sintering step. The grinding may also be performed prior to both steps.

Preferably, the mixture used for the sintering comprises or consists of crystalline Al₂O₃ and crystalline TiO₂ in a molar ratio of 1:1.

The barium titanate compound may be prepared according to the dry route by mixing a mixture comprising or consisting of crystalline BaCO₃ and crystalline TiO₂, e.g. rutile, followed by sintering the mixture (see, for example, J. Mat. Sci. Technol. (2007), p. 655-658). Optionally, and in order to have smaller average primary particle diameters of the crystalline educts prior to sintering, the crystalline BaCO₃ and/or the crystalline TiO₂ may be grinded prior to the mixing step or prior to the sintering step. The grinding may also be performed prior to both steps.

Preferably, the mixture used for the sintering comprises or consists of crystalline BaCO₃ and crystalline TiO₂ in a molar ratio of 1:1.

The calcium titanate compound may be prepared according to the dry route by mixing a mixture comprising or consisting of crystalline CaCO₃ and crystalline TiO₂, e.g. rutile, followed by sintering the mixture (see, for example, Mat. Res. Bulletin (2003), 38(7), p. 1203-1213). Optionally, and in order to have smaller average primary particle diameters of the crystalline oxides prior to sintering, the crystalline Al₂O₃ and/or the crystalline TiO₂ may be grinded prior to the mixing step or prior to the sintering step. The grinding may also be performed prior to both steps.

Preferably, the mixture used for the sintering comprises or consists of crystalline CaCO₃ and crystalline TiO₂ in a molar ratio of 1:1.

The zinc titanate compound may be prepared according to the dry route by mixing a mixture comprising or consisting of crystalline ZnO and crystalline TiO₂, e.g. rutile, followed by sintering the mixture (see, for example, Ceramics International (2004), 30(8), p. 2183-2189).

After the step of mixing, or after the optional step(s) of grinding, the mixture is sintered to obtain the aluminum titanate compound, the barium titanate compound, the calcium titanate compound, or the zinc titanate compound used according to the invention.

After sintering, the aluminum titanate compound, the barium titanate compound, the calcium titanate compound or the zinc titanate compound used for the invention preferably has an average primary particle diameter in the range of 100 nm to 500 μm, preferably 300 nm to 100 μm, more preferably 400 nm to 50 μm, and most preferably 500 nm to 2000 nm. In order to obtain the desired average primary particle diameter of the crystalline oxides, the sintered aluminum titanate compound, the barium titanate compound, the calcium titanate compound or the zinc titanate compound may be grinded prior to be used according to the invention.

Average primary particle sizes in the μm range of the aluminum titanate, the barium titanate compound, the calcium titanate compound or the zinc titanate compound obtained via the dry route were determined by light microscopy in transmitted light. The VHX-1000 digital microscope system from Keyence with the VH-Z250R zoom lens was used for this purpose. A 2.5% suspension of the solid to be examined in ethylene glycol was placed on a microscope slide and covered with a cover slip.

Average primary particle sizes in the nm range were determined by dynamic light scattering (DLS) using a Litesizer 100 from Anton Paar GmbH. A 0.1% suspension of the solid to be examined in ethylene glycol was measured in a cuvette.

The total amount of the one or more catalysts comprised in the inventive composition may be from 0.1 ppm to 400 ppm, preferably from 1 ppm to 200 ppm, more preferably from 2 ppm to 120 ppm, based on the weight of the at least one polyacid and the at least one polyol.

According to the wet-chemical route the aluminum titanate compound is prepared by a wet-chemical process comprising the steps of reacting an aluminum compound with a titanium compound in a solvent, precipitating the reaction product, calcinating the precipitated reaction product, and obtaining the aluminum titanate compound.

As aluminum compound for the wet-chemical route aluminum alcoholates, aluminum acetate, aluminum nitrate or aluminum citrate may be used. As titanium compound titanium alcoholates, titanium acetate, titanium halides or titanium citrate may be used. The aluminum and titanium compounds are reacted using a sol-gel process. An exemplary synthesis of aluminum titanate compound in powder form using the sol-gel technology is described by H. G. Riella et al., Trans. Tech. Publ. 416 (2003) 519-524.

As barium compound for the wet-chemical route barium acetate may be used. As titanium compound titanium isopropoxide may be used. The barium and titanium compounds are reacted using a sol-gel process. An exemplary synthesis of barium titanate compound using the sol-gel technology is described in J. Mat. Chem (1992), 2, p. 591-94.

As calcium compound for the wet-chemical route calcium acetate may be used. As titanium compound titanium isopropoxide may be used. The calcium and titanium compounds are reacted using a sol-gel process. An exemplary synthesis of calcium titanate compound using the sol-gel technology is described in Chem. Mat. (1994), 6, p. 58-62.

As zinc compound for the wet-chemical route zinc acetate may be used. As titanium compound titanium butylate may be used. The zinc and titanium compounds are reacted using a sol-gel process. An exemplary synthesis of zinc titanate compound using the sol-gel technology is described in J. of Crystal Growth (2002), 243 (2), p. 319-326.

After calcinating the above described precipitated reaction products and obtaining the aluminum titanate compound, the barium titanate compound, the calcium titanate compound, or the zinc titanate compound via the wet-chemical process, the aluminum titanate compound, the barium titanate compound, the calcium titanate compound, or the zinc titanate compound can have an average primary particle diameter of less than 100 nm, preferably less than 50 nm and most preferably less than 25 nm.

The average primary particle diameter of the aluminum titanate compound, the barium titanate compound, the calcium titanate compound or the zinc titanate compound obtained via the wet-chemical route is determined according to the following method: Colloidal dispersions of AlTi prepared by known methods (or colloidal dispersions of any other of the titanate compounds as described above like BaTi, CaTi, ZnTi or any mixture of two, three or four of AITi, BaTi, CaTi, ZnTi) are diluted (e.g. to 0.025 wt %), and a drop of the solution is placed on a 3 mm Cu grid coated with a 200-mesh carbon film. A drop of colloidal dispersion is also placed on a 3 mm Au grid coated with a holey carbon film. The grid is placed on a paper sheet that absorbed liquid flowing through the perforated film, and the sample is left to dry in air before being stored in a plastic container sealed with Parafilm prior to electron microscopy analysis. SEM analyses are carried out at randomly chosen areas using 40,000× magnification at 300 KV. The sample distribution for electron micrographs is determined using a suitable software, such as Image J. The size distribution is measured with an interval of 1 nm. The Gaussian distribution is indicated by a solid line in the graphs. The above described method follows the procedure described in C. Shin et al 2019, ECS J. Solid State Sci. Technol. 8, p. 3195-3200.

Examples of the titanate compounds prepared for the use and/or used according to the invention are Al₂TiO₅ as an aluminum titanate compound, BaTiO₃ as a barium titanate compound, CaTiO₃ as a calcium titanate compound, and ZnTiO₃, Zn₂TiO₄ or Zn₂Ti₃O₈ as zinc titanate compounds.

The present invention is also directed to a method for producing a polyester, thereby using one or more catalysts. The inventive method comprises the steps of: providing a reaction mixture comprising at least one polyacid and at least one polyol;
esterifying the at least one polyacid and the at least one polyol in the reaction mixture, optionally in the presence of the one or more catalysts, to produce a monomer;
polymerizing the monomer in the reaction mixture by way of polycondensation in the presence of the one or more catalysts to form a polyester;
wherein at least one of the catalysts is an aluminum titanate compound comprising aluminum, titanium and oxygen atoms, or is a barium titanate compound comprising barium, titanium and oxygen atoms, or is a calcium titanate compound comprising calcium, titanium and oxygen atoms, or is a zinc titanate compound comprising zinc, titanium and oxygen atoms or is a mixture of two, three or four of said titanate compounds comprising titanium and oxygen atoms together with the respective atoms of aluminum, barium, calcium, and/or zinc; and
wherein the aluminum titanate compound, or the barium titanate compound, the calcium titanate compound, or the zinc titanate compound or the mixture of the titanate compounds is in a crystalline form.

For further details and/or preferable options of the inventive method, particularly with respect to the one or more catalysts, the at least one polyacid and the at least one polyol, the monomer, the aluminum titanate compound, the barium titanate compound, the calcium titanate compound or the zinc titanate compound or a mixture of these titanate compounds and its preparation methods, it is referred to the above description of the inventive composition which is applicable mutatis mutandis to the inventive method for producing a polyester. Further details and/or preferable options follow below.

Typically, the aluminum titanate compound, the barium titanate compound, the calcium titanate compound or the zinc titanate compound, or a mixture of these titanate compounds, is added to the reaction mixture in an amount so that titanium is present from 1 ppm to 100 ppm, preferably from 5 ppm to 50 ppm, most preferably from 10 ppm to 30 ppm, based on the weight of the sum of the at least one polyacid and the at least one polyol of the composition, or based on the polyester produced.

According to the invention it is recommended if more than 10% by weight of the one or more catalysts used in the polycondensation step, and optionally in the esterification step, are the aluminum titanate compound, the barium titanate compound, the calcium titanate compound, the zinc titanate compound or a mixture of these titanate compounds in a crystalline form. Preferably, more than 30% by weight, and more preferably more than 50% by weight, of the one or more catalysts used in the polycondensation step, and optionally in the esterification step, are the aluminum titanate compound in a crystalline form. However, most preferably more than 80% by weight, or even 100% by weight, of the one or more catalysts used in the polycondensation step, and optionally in the esterification step, are the aluminum titanate compound, the barium titanate compound, the calcium titanate compound, the zinc titanate compound or a mixture of these titanate compounds in a crystalline form.

As already mentioned above, the aluminum titanate compound, the barium titanate compound, the calcium titanate compound, the zinc titanate compound or a mixture of these titanate compounds used in the esterification step and/or in the polycondensation step can be free of rare earth elements, and/or can be free of organic groups.

The same applies to the optional further catalysts which may be used in the method according to the invention. Thus, catalysts comprising rare earth elements can be excluded from the one or more catalysts used in the esterification step and/or in the polycondensation step, and/or catalysts comprising organic groups can be excluded from the one or more catalysts used in the esterification step and/or in the polycondensation step.

Also, in the esterification step and/or in the polycondensation step antimony compounds can be used in an amount of less than 200 ppm, and preferably less than 100 ppm. Most preferably, no antimony compounds are used in the inventive method for producing a polyester.

The preferred polyester formed in the method according to the invention is polyethylene terephthalate.

In an advantageous variation of the inventive method, the method further comprises the step of adding recycled polyethylene terephthalate prior to or during the esterification step and/or prior to or during the polycondensation step in an amount of from 10 to 100% by weight, preferably in an amount of from 30 to 100% by weight, more preferably in an amount of from 50 to 100% by weight, and most preferably in an amount of from 80 to 100% by weight, based on the total amount of the provided at least one polyacid and the at least one polyol, or based on the polyester produced.

The aluminum titanate compound, the barium titanate compound, the calcium titanate compound, the zinc titanate compound or a mixture of these titanate compounds may be used in both the melt phase and the solid state phase of the polycondensation reaction at a concentration of from 1 to 250 ppm, preferably from 1 to 100 ppm and most preferred from 5 to 75 ppm by weight based on the total amount of the provided at least one polyacid and the at least one polyol, or based on the polyester finally formed.

Further, the aluminum titanate compound, the barium titanate compound, the calcium titanate compound, the zinc titanate compound or a mixture of these titanate compounds used in the catalyst composition according to the present invention has a good stability against hydrolysis. This allows the catalyst to be used as an esterification catalyst and to catalyze esterification reactions. The aluminum titanate compound, the barium titanate compound, the calcium titanate compound, the zinc titanate compound or a mixture of these titanate compounds according to the invention may be in form of a powder. The aluminum titanate powder, the barium titanate powder, the calcium titanate powder, the zinc titanate powder or the powder of a mixture of these titanate compounds may be added to the polyacid and the polyol (the suspension of these also referred to herein as “paste”) before the esterification reaction. The catalyst-containing suspension may also be added directly to the esterification reaction, or directly to the polycondensation reaction. The catalyst works at the same temperatures and pressures as antimony catalysts typically described in the prior art.

The aluminum titanate compound, the barium titanate compound, the calcium titanate compound, the zinc titanate compound or a mixture of these titanate compounds is also insoluble in water and is not soluble in most organic solvents. Solvents in context of the present invention can be polar and non-polar liquid organic molecules having a carbon based structure and a boiling point below 250° C. that may serve to dissolve reactants, such as the polyacids or the polyols or also antimony compounds. The organic solvents can be linear, branched or cyclic alkanols; linear, branched or cyclic alkanes; linear, branched or cyclic alkenes; linear, branched or cyclic ether; linear, branched or cyclic esters; and molecules having an aromatic ring structure, for example, benzene, toluene and xylene; and combinations of the foregoing.

According to the invention, the one or more catalysts of the above composition or used in the above method comprises the aluminum titanium compound, the barium titanate compound, the calcium titanate compound, the zinc titanate compound or a mixture of these titanate compounds and may comprise one or more further catalyst(s), which may be homogeneous catalyst(s). The homogeneous catalysts for polycondensation and/or esterification reactions may be, for example, germanium-containing compounds, titanium-containing compounds other than the aluminum titanate compound, the barium titanate compound, the calcium titanate compound, the zinc titanate compound or a mixture of these titanate compounds described above, such as titanium alcoholates, or antimony (III)-containing compounds, such as antimony oxide, antimony acetate or antimony glycolate. Antimony (III) compounds employed in catalyzed polycondensation reactions increase selectivity and reaction rate. The content in undesirable degradation products, such as acetaldehyde, is also low in the processed polyester, compared to conventional titanium alcoholate or other homogeneous catalysts for instance.

In addition, the reaction rate of the two reaction steps of polycondensation (melt phase and SSP) depends not only on the temperature, but also on the diffusion of volatile reaction products, such as ethylene glycol or acetaldehyde.

The aluminum titanate compound, the barium titanate compound, the calcium titanate compound or a mixture of these titanate compounds used as catalyst in the present invention may be used in form of a fixed bed catalyst or in form of a catalyst powder. In case the catalyst being a powder, it may be added directly to the catalyst composition before the esterification reaction. Beneficially, by suspending the catalyst powder before adding it to the reaction components comprising the at least one polyacid and the at least one polyol, a re-agglomeration of the fine particles may be avoided. An additional antimony catalyst may be dissolved in a suitable polyol such as ethylene glycol. The antimony catalyst-containing solution may be added directly to the paste, whereupon the paste is added to the esterification step, or to the polycondensation step.

The additional antimony (III) catalyst may be present in an amount between 50 to 350 ppm by weight, preferably in an amount of 150 to 300 ppm by weight, most preferably in an amount of 200 to 300 ppm by weight, based on elemental antimony in the final polymer.

The final product of the polyester manufacturing, in particular PET manufacturing, employing the catalyst as described above, may be further processed to provide a PET bottle. PET bottles are manufactured by stretch blow molding a preform made of PET to obtain the PET bottle. The “preform” as herein referred to means an injection molded item that is meant to be stretch blow molded into a bottle, the material the preform and the bottle are made of is preferably PET.

The crystallization behavior of PET produced with the catalyst composition according to the invention is similar to that of PET catalyzed with conventional antimony (III) catalysts. In the product catalyzed with antimony, elemental antimony nanoparticles act as a crystallization nucleus and induces crystallization within the PET. In the PET products being catalyzed with the catalyst composition comprising aluminum titanate compounds, barium titanate compounds, calcium titanate compounds, zinc titanate compounds or a mixture of these titanate compounds, it is the heterogeneously acting catalyst itself that acts as the crystallization nucleus.

The final product of the catalyzed polycondensation reaction employing the catalyst comprising at least an aluminum titanate compound, the barium titanate compound, the calcium titanate compound, the zinc titanate compound or a mixture of these titanate compounds can be a food-grade polyester. In particular, the food-grade PET is provided using up to 100% by weight of recycled PET as feedstock. Beneficially, using recycled PET reduces the need for virgin PET, thereby helping close the loop in the circular economy. Preferably, the food-grade PET comprises from 1 to 100%, more preferably from 10 to 100%, and most preferably 25 to 100% by weight of recycled polyethylene terephthalate as the feedstock for manufacturing the final PET, wherein the catalyst comprising the inventive aluminum titanate compound, the barium titanate compound, the calcium titanate compound, the zinc titanate compound or a mixture of these titanate compounds is employed.

The final product of the catalyzed polycondensation reaction PET may comprise up to 25% by weight, preferably up to 50% by weight, most preferred up to 100% by weight of recycled PET for the use in beverage bottle production or in thermoforming applications, such as film packaging.

The amount of the aluminum titanate compound, the barium titanate compound, the calcium titanate compound, the zinc titanate compound or a mixture of these titanate compounds is calculated based on the amount of the elemental titanium required to catalyze the reaction which is to be catalyzed. For example, 57 ppm of aluminum titanate compound as catalyst corresponds to 15 ppm elemental titanium (73 ppm barium titanate compound corresponds to 15 ppm elemental titanium; 43 ppm calcium titanate compound corresponds to 15 ppm elemental titanium; 51 ppm zinc titanate compound corresponds to 15 ppm elemental titanium). In preferred embodiments, wherein the one or more catalysts used in the catalyst composition consists of the inventive aluminum titanate compound, the barium titanate compound, the calcium titanate compound, the zinc titanate compound or a mixture of these titanate compounds only, the catalyst comprises a total amount of from 1 to 100 ppm, more preferably from 5 ppm to 50 ppm, and most preferably from 10 ppm to 20 ppm elemental titanium based on the weight of the at least one polyacid and the at least one polyol, or based on the polyester produced.

Although polymerization catalysts increase the rate of polymerization of the monomer, these catalysts will begin to degrade the polyester (e.g. PET) and thus, adversely affecting the thermal stability of the polymer. A thermally stable polyester refers to a polyester which has low acetaldehyde content, low discoloration and high retention of molecular weight after subsequent heat treatment or processing. Acetaldehyde formation is an objectionable result of degradation, especially in the food and beverage industry, because it can adversely affect the taste of the bottled product, even when present in very small amounts. In addition, degradation of the polymer will typically cause discoloration or yellowing of the polymer, which is undesirable in most applications. High amounts and a high activity of catalysts are therefore rather to be avoided.

The catalyst composition may further comprise less than 5 ppm of a catalyst deactivator comprising phosphor, based on the weight of the phosphor. In such a case when a catalyst deactivator comprising phosphor is present, the deactivator is not added directly into the catalyst suspension.

Any stabilizer which will deactivate the polymerization catalyst (thus preventing the degradation and discoloration of the polyester) is suitable as a deactivator. Generally, a thermal stabilizer is nonreactive with the polymer and possesses low residual moisture.

The aluminum titanate compound, the barium titanate compound, the calcium titanate compound, the zinc titanate compound or a mixture of these titanate compounds used as catalyst may be employed using the same solvents, temperatures and general conditions as for antimony-containing catalysts. Compared to the homogeneous catalysts comprising titanium, e.g. titanium alcoholate, the titanium-containing heterogeneous catalyst according to the present invention exhibits a lower reactivity for side reactions and thus, does not require a catalyst deactivator. Thus, in preferred embodiments of the present invention the catalyst composition for the polyester polycondensation reaction is free of a catalyst deactivator.

The polyester obtained by the method according to the invention, may be a high molecular weight acyclic polyester (molecular weight above 10 000 g·mol⁻¹, preferably above 20 000 g·mol⁻¹) having an intrinsic viscosity above 0.7 dL·g⁻¹, such as polyethylene terephthalate (PET), polyethylene furanoate (PEF), polybutylene terephthalate (PBT), polytrimethylene terephthalate (PTT), and polyethylene naphthalate (PEN). Preferably, the polyester is PET.

In general, the esterification step can be carried out without any catalyst (autocatalysis), but typically, metal compounds are added to catalyze the esterification reaction. The esterification step may be conducted at a temperature of above 200° C., more preferably at a temperature of from 240° C. to 300° C., and at a pressure of from 1 to 10 bar.

The second step of manufacturing high molecular weight acyclic polyesters, such as PET, is the polycondensation step. The polycondensation step is important for molecular weight build-up of the polyester. The polycondensation reaction may include two phases, a melt phase and a solid state phase (SSP). Typically, the melt phase of the polycondensation step is conducted at a temperature of from 240° C. to 300° C. and at a reduced pressure from 4 to 0.1 mbar. Typically, the SSP of the polycondensation step is conducted at a temperature of from 190° C. to 230° C. and may be conducted either under nitrogen flow or under reduced pressure from 3 to 0.1 mbar.

The catalyst of the present invention comprising an aluminum titanate compound, a barium titanate compound, a calcium titanate compound, a zinc titanate compound or a mixture of these titanate compounds may be added to the melt phase of the polycondensation step. The amount of titanium added as the aluminum titanate compound, the barium titanate compound, the calcium titanate compound and/or the zinc titanate compound to the polyester polycondensation reaction is from 1 ppm to 100 ppm, preferably from 5 ppm to 50 ppm, based on the weight of the at least one polyacid and the at least one polyol, or based on the weight of the polyester.

In preferred embodiments the aluminum titanate compound, the barium titanate compound, the calcium titanate compound, the zinc titanate compound or a mixture of these titanate compounds added to the method according to the invention may be in form of a powder, preferably in from of a nanopowder having a primary particle diameter of less than 75 nm, preferably less 50 nm and most preferred less than 25 nm. The particle size has been evaluated relying on SEM (Scanning Electron Microscopy) image analysis as described above. The catalyst may be added as a catalyst composition, comprising an aluminum titanate compound (or a barium titanate compound, or a calcium titanate compound, or a zinc titanate compound, or a mixture of these titanate compounds) and at least one polyacid and at least one polyol, before the esterification reaction.

In certain embodiments, wherein the catalyst comprises an aluminum titanium compound (or a barium titanate compound, or a calcium titanate compound, or a mixture of these titanate compounds) and an antimony (III)-containing compound, both components may be added directly to the paste before the esterification reaction. Alternatively, the antimony catalyst may be dissolved in a suitable polyol such as ethylene glycol. The antimony catalyst-containing solution may then be added to the paste, and catalyze the esterification reaction, or the polycondensation reaction.

Beneficially, by adding the aluminum titanate compound, the barium titanate compound, the calcium titanate compound, the zinc titanate compound or a mixture of these titanate compounds instead of conventional titanium alcoholates, e.g. titanium tetrabutylate, the acetaldehyde regeneration rates during the processing, even in the absence of deactivators, e.g. phosphoric acid or potassium acetate, are lower or equal compared to a method comprising only antimony catalysts.

The product obtained by the method according to the invention, may be further processed to provide a PET bottle as described above. In preferred embodiments, the product obtained by the method for producing a polyester may be a food-grade polyester.

In particular, the method according to the invention may further comprise the addition of recycled polyethylene terephthalate. Preferably, from 10 to 100% by weight of recycled polyethylene terephthalate based on the weight of the final polyester product may be added to the method according to the invention. More preferred, about 25 to 100% of the final polyethylene terephthalate based on the weight of the final polyester product may be substituted with the recycled polyethylene terephthalate. The final product of the method according to the invention may comprise up to 100% of recycled PET and may be suitable for applications in beverage bottle production or in thermoforming applications, such as film packaging.

The total amount of the catalyst added to the polyester polycondensation reaction may be from 1 ppm to 400 ppm, preferably from 5 ppm to 200 ppm, and most preferred from 1 ppm to 100 ppm, based on the weight of the at least one polyacid and the at least one polyol, or based on the weight of the final polyester.

According to certain embodiments of the present invention, a catalyst deactivator as described above may be added to the method for producing a polyester. Preferably, the catalyst deactivator is added to the polycondensation reaction.

Applying the method as described above, it is possible to increase the polycondensation rates in the melt phase of the polycondensation reaction.

The present invention is also directed to the use of an aluminum titanate compound, a barium titanate compound, a calcium titanate compound, a zinc titanate compound or a mixture of these titanate compounds in a crystalline form as a heterogeneous catalyst in a polyester polycondensation reaction.

The use of the aluminum titanate compound, the barium titanate compound, the calcium titanate compound, the zinc titanate compound or a mixture of these titanate compounds as catalyst in polycondensation reactions leads to a final product that, in contrast of using conventional titanium catalysts, such as titanium alcoholates, causes a relatively low yellowing in the final product and thus, a manageable discoloration of the final product.

### EXAMPLES

PET was produced using a conventional antimony (III) based catalyst or a crystalline titanium based catalyst according to the invention by the following procedure:

Monoethylene glycol (MEG) (242 g), 0.02 g of an aqueous solution (25%) of tetramethyl-ammonium hydroxide (TMAH, used to inhibit formation of diethylene glycol), 250 ppm antimony (added as 0.6543 g antimony glycolate) or 10, 15, 20 ppm titanium (added as 38, 57 and 76 ppm crystalline aluminum titanate (AITi), and 73 ppm crystalline barium titanate (BaTi), and 43 ppm crystalline calcium titanate (CaTi), and 51 ppm crystalline zinc titanate (ZnTi), respectively), or crystalline magnesium titanium oxide (MgTiO₃), were fed into a glass beaker, which was used to mix the raw materials before being fed into a reactor. Under stirring, purified terephthalic acid and isophthalic acid (PTA and IPA: 500 g) were added into the glass beaker. The MEG/PTA paste was then stirred and fed into the reactor. Full vacuum was applied to the reactor and then the reactor was aerated with nitrogen to remove traces of oxygen. This procedure was repeated three times.

### Esterification

The set points for reactor temperature and pressure for the esterification were approximately 300° C. and 4 bar (absolute). The condensed ethylene glycol (EG) and water (at the top of the reactor) was collected in a bottle. During the esterification time the product temperature increases to approximately 260° C. The esterification run (E1) lasts approximately 120 minutes.

After esterification (E1) the pressure is decreased to 1.0 bar (absolute). After additional stirring of the reaction mixture for 7.5 minutes at 1 bar (absolute) (E2), approx. 75% of the reaction mixture were pulled out of the reactor.

### Melt Phase Polycondensation

The stirrer speed was reduced to 30 rpm and the polycondensation process was started by applying a vacuum of 40 mbar for 1.5 minutes. After this, full vacuum was applied.

During the polycondensation, the product temperature increased to 270° C. The polycondensation was finished at a fixed value for the power consumption of the electric stirrer.

### Solid State Polycondensation (SSP)

The SSP reactor for Buchi products was a fixed bed reactor from company Roth. The reactor had a batch capacity of 22 g. The temperature was kept to 210° C. by a heating jacket. The preheated nitrogen flow used had a dew point of better −30° C. and flows through the reactor from the ground to the head through the entire pellet bed with 15 I/h.

### Example 1

The reaction rate constants k for the melt phase polycondensation and for the SSP polycondensation were determined separately for the PET catalyzed with the conventional antimony (III) (comparative example), with magnesium titanium oxide, MgTiO₃, (as a further comparative example), and for PET catalyzed with 10, 15 and 20 ppm Titanium (Ti, added as 38, 57 and 76 ppm AITi, 73 ppm BaTi, 43 ppm CaTi, 51 ppm ZnTi respectively) according to the invention, by weight of the final polymer. The results are shown in table 1.

TABLE 1

| Catalyst | Amount [ppm] | kₘₑₗₜ [% Sb] | k_{SSP} [% Sb] |
|---|---|---|---|
| Antimony (III) | 250 | 100 | 100 |
| Ti (as AlTi) | 10 | 97 | 76 |
| Ti (as AlTi) | 15 | 111 | 84 |
| Ti (as AlTi) | 20 | 111 | 84 |
| Ti (as BaTi) | 15 | 133 | 85 |
| Ti (as CaTi) | 15 | 136 | 97 |
| Ti (as MgTiO₃) | 15 | 118 | 72 |
| Ti (as ZnTi) | 15 | 130 | 117 |

The results demonstrate that very small amounts of Ti are sufficient to achieve a similar or an even higher polycondensation rate in case of the melt phase reaction. The polycondensation rates of the Ti catalyzed PET in the SSP are slightly lower compared to the antimony catalyzed PET.

### Example 2

The color values L*, a* and b* are averages of values measured on either polyester pellets or plaques or other items injection molded or extruded from them. They are determined by the L*a*b* color system of the CIE (International Commission on Illumination), wherein L* represents the lightness coordinate, a* represents the red/green coordinate, and b* represents the yellow/blue coordinate.

The color measurements were carried out using a spectral photometer CM-3700A (Konica Minolta) with SPECTRA Magic software and by applying the following parameters for pellet measurements:
Spectral range: 380 to 720 nm
Principle: diffuse reflection, d/8°; SEC, UV 0%
Cuvette: height; 50 mm, width: 35 mm, depth: 20 mm
Measuring spot: Ø 25 mm
Illuminant: daylight D65/10
Reference: black and white calibration

The samples were measured in their pellet form. The cuvette was cleaned and filled to at least 85% of the maximum volume. The sample was measured four times, while each measurement required new sample pellets. The average value of all 4 measurements as well as the CIELab L*a*b* value was calculated using SPECTRA MAGIC software. The results are shown in table 2.

TABLE 2

| Catalyst | Amount [ppm] | b*ₘₑₗₜ [—] | b*_{SSP}[—] |
|---|---|---|---|
| Antimony (III) | 250 | 2.3 | 5.2 |
| Ti (as AlTi) | 10 | 4.8 | — |
| Ti (as AlTi) | 15 | 5.0 | 8.3 |
| Ti (as AlTi) | 20 | 5.9 | 8.7 |
| Ti (as BaTi) | 15 | 6.9 | 9.1 |
| Ti (as CaTi) | 15 | 9.0 | 11.0 |
| Ti (as MgTiO₃) | 15 | 8.2 | 10.4 |
| Ti (as ZnTi) | 15 | 7.8 | 10.2 |

The results demonstrate that AITi, BaTi, CaTi and ZnTi and the conventional antimony catalyst both cause a yellowing effect (b* value above 0) of the final polymer. Beneficially, by using AlTi as a catalyst in polycondensation reactions instead of conventional titanium alcoholates (results are not shown), the yellowing of the final product is comparable to that of antimony catalyzed PET. Using BaTi, CaTi or ZnTi as a catalyst in polycondensation reactions, the yellowing of the final product is slightly higher to that of antimony catalyzed PET.

### Example 3

The acetaldehyde content (AA) of the processed PET was determined according to the following method:

At first, the sample material was ground with a 1 mm screen in a centrifugal mill by RETSCH Co. (ZM200) in the presence of liquid nitrogen. Approximately 0.1 g to 0.3 g of the ground material was put into a 22 ml sample bottle and sealed with a polytetrafluoroethylene seal. The sample bottles were heated under controlled temperature in a headspace oven (TurboMatrix-40 headspace autosampler by Perkin Elmer) at 150° C. for 90 minutes, and subsequently analyzed through gas chromatography (XL GC AutoSystem by Perkin Elmer) with an external standard. The calibration curve was prepared through complete evaporation of aqueous solutions of different AA.

The headspace autosampler conditions for the acetaldehyde determination were as follows:
Oven temperature: 150° C.
Needle temperature: 160° C.
Transfer line temperature: 170° C.
Retention Time: 90 minutes
Gas chromatograph conditions: Column: 1.8 m×⅛ in stainless steel
Packing: Porapack Q, 80/100 mesh
Carrier gas: nitrogen, 30 ml/min
Fuel gas: hydrogen
Air: synthetic air
Column temperature: 140° C.
Detector temperature: 220° C.

Table 3 shows the results of the acetaldehyde contents (AA) measurements.

TABLE 3

| Catalyst | Amount [ppm] | AA [% Sb] |
|---|---|---|
| Antimony | 250 | 100 |
| Ti (as AlTi) | 10 | 83 |
| Ti (as AlTi) | 15 | 102 |
| Ti (as AlTi) | 20 | 80 |
| Ti (as BaTi) | 15 | 88 |
| Ti (as CaTi) | 15 | 73 |
| Ti (as MgTiO₃) | 15 | 106 |
| Ti (as ZnTi) | 15 | 182 |

It is surprising that the acetaldehyde values after processing the AITi, BaTi or CaTi catalyzed PET is comparable to standard products catalyzed with antimony. It is of importance that this effect was achieved without the addition of phosphorus compounds (stabilizers) that are usually mandatory for titanium catalysis. The conventional deactivation mechanism of titanium based polycondensation catalysts is that Ti—O—Ti bonds are formed. This can be excluded by fixing them in the crystal lattice of the inorganic structure of AITi, BaTi or CaTi.

In summary, the AITi, BaTi or CaTi were found to be excellent heterogeneous catalysts for PET polycondensation reactions. A manageable discoloration, lower or equal acetaldehyde regeneration rates during processing, increased or similar polycondensation rates (melt phase) and only slightly lower polycondensation rates (SSP) compared to antimony compounds were observed. It was demonstrated that AITi, BaTi or CaTi can replace the conventional antimony catalysts in the polyester polycondensation reaction without a negative impact on the production process and final product properties.

1. A composition for a polyester polycondensation reaction, comprising:
one or more catalysts, wherein at least one of the catalysts is a titanate compound selected from the group consisting of an aluminum titanate compound, a barium titanate compound, a calcium titanate compound, and a zinc titanium compound or is a mixture of two, three or four of said titanate compounds, wherein the aluminum titanate compound comprises aluminum, titanium and oxygen atoms, wherein the barium titanate compound comprises barium, titanium and oxygen atoms, wherein the calcium titanate compound comprises calcium, titanium and oxygen atoms, wherein the zinc titanate compound comprises zinc, titanium and oxygen atoms, and wherein in case of a mixture of two, three or four of said titanate compounds the mixture comprises titanium atoms and oxygen atoms together with the respective atoms of aluminum, barium, calcium and/or zinc; and
at least one polyacid and at least one polyol;
wherein the titanate compound or the mixture of the titanate compounds is in a crystalline form.

2. The composition according to claim 1, wherein the amount of titanium in form of the titanate compound or the mixture of the titanate compounds in a crystalline form in the composition is from 1 ppm to 100 ppm by weight, preferably from 4 ppm to 50 ppm by weight, and more preferably from 8 ppm to 30 ppm by weight, based on the total weight of the sum of the at least one polyacid and/or the at least one polyol of the composition, or based on the polyester formed by the polyester polycondensation reaction.

3. The composition according to claim 1, wherein the titanate compound or the mixture of the titanate compounds is free of rare earth elements, and/or wherein the titanate compound or the mixture of the titanate compounds is free of organic groups.

4. The composition according to claim 1, wherein catalysts comprising rare earth elements are excluded from the one or more catalysts of the composition, and/or wherein catalysts comprising organic groups are excluded from the one or more catalysts of the composition.

5. The composition according to claim 1, wherein the composition comprises less than 200 ppm antimony compounds, preferably less than 100 ppm antimony compounds, and most preferably, wherein the composition is free of antimony compounds.

6. The composition according to claim 1,
wherein a) the aluminum titanate compound is a mixed oxide comprising aluminum oxide, titanium dioxide, and, optionally, water of crystallization; or b) the aluminum titanate compound consists of aluminum atoms, titanium atoms, oxygen atoms, and, optionally, water of crystallization; or
wherein a) the barium titanate compound is a mixed oxide comprising barium oxide, titanium dioxide, and, optionally, water of crystallization; or b) the barium titanate compound consists of barium atoms, titanium atoms, oxygen atoms, and, optionally, water of crystallization; or
wherein a) the calcium titanate compound is a mixed oxide comprising calcium oxide, titanium dioxide, and, optionally, water of crystallization; or b) the calcium titanate compound consists of calcium atoms, titanium atoms, oxygen atoms, and, optionally, water of crystallization; or
wherein a) the zinc titanate compound is a mixed oxide comprising zinc oxide, titanium dioxide, and, optionally, water of crystallization; or b) the zinc titanate compound consists of zinc atoms, titanium atoms, oxygen atoms, and, optionally, water of crystallization; or
wherein a) the mixture of the titanate compounds is a mixture of two, three or four of the mixed oxides, optionally together with water of crystallization; or b) the mixture of the titanate compounds consists of titanium atoms and oxygen atoms together with the respective atoms of aluminum, barium, calcium, and/or zinc optionally together with water of crystallization.

7. The composition according to claim 1,
wherein the aluminum titanate compound is prepared by sintering a mixture comprising or consisting of a crystalline Al₂O₃ and a crystalline TiO₂; or
wherein the barium titanate compound is prepared by sintering a mixture comprising or consisting of a crystalline BaCO₃ and a crystalline TiO₂; or
wherein the calcium titanate compound is prepared by sintering a mixture comprising or consisting of a crystalline CaCO₃ and a crystalline TiO₂; or
wherein the zinc titanate compound is prepared by sintering a mixture comprising or consisting of a crystalline ZnO and a crystalline TiO₂; or
wherein the mixture of the titanate compounds is prepared by sintering a mixture comprising or consisting of a crystalline TiO₂ with two, three or four of the following: a crystalline Al₂O₃, a crystalline BaCO₃, a crystalline CaCO₃, and a crystalline ZnO.

8. The composition according to claim 1,
wherein the aluminum titanate compound is prepared by a wet-chemical process comprising the steps of reacting an aluminum compound with a titanium compound in a solvent, precipitating the reaction product, and calcinating the precipitated reaction product, preferably wherein the aluminum titanate compound has an average primary particle diameter, measured as defined in the description, of less than 100 nm, preferably less than 50 nm and most preferably less than 25 nm; or
wherein the barium titanate compound is prepared by a wet-chemical process comprising the steps of reacting a barium compound with a titanium compound in a solvent, precipitating the reaction product, and calcinating the precipitated reaction product, preferably wherein the barium titanate compound has an average primary particle diameter, measured as defined in the description, of less than 100 nm, preferably less than 50 nm and most preferably less than 25 nm; or
wherein the calcium titanate compound is prepared by a wet-chemical process comprising the steps of reacting a calcium compound with a titanium compound in a solvent, precipitating the reaction product, and calcinating the precipitated reaction product, preferably wherein the calcium titanate compound has an average primary particle diameter, measured as defined in the description, of less than 100 nm, preferably less than 50 nm and most preferably less than 25 nm, or
wherein the zinc titanate compound is prepared by a wet-chemical process comprising the steps of reacting a zinc compound with a titanium compound in a solvent, precipitating the reaction product, and calcinating the precipitated reaction product, preferably wherein the zinc titanate compound has an average primary particle diameter, measured as defined in the description, of less than 100 nm, preferably less than 50 nm and most preferably less than 25 nm.

9. The composition according to claim 1, wherein the at least one polyacid is terephthalic acid and the at least one polyol is ethylene glycol.

10. A method for producing a polyester, thereby using one or more catalysts, the method comprising the steps of:
providing a reaction mixture comprising at least one polyacid and at least one polyol;
esterifying the at least one polyacid and the at least one polyol in the reaction mixture, optionally in the presence of one or more catalysts, to produce a monomer;
polymerizing the monomer in the reaction mixture by way of polycondensation in the presence of one or more catalysts to form a polyester;
wherein at least one of the catalysts is an aluminum titanate compound comprising aluminum, titanium and oxygen atoms; or
wherein at least one of the catalysts is a barium titanate compound comprising barium, titanium and oxygen atoms; or
wherein at least one of the catalysts is a calcium titanate compound comprising calcium, titanium and oxygen atoms; or
wherein at least one of the catalysts is a zinc titanate compound comprising zinc, titanium and oxygen atoms; or
wherein at least one of the catalysts is a mixture of two, three or four of said titanate compounds comprising titanium and oxygen atoms together with the respective atoms of aluminum, barium, calcium and/or zinc, and
wherein the titanate compound or the mixture of the titanate compounds is in a crystalline form.

11. The method according to claim 10, wherein the method further comprises the step of adding recycled polyethylene terephthalate prior to or during the esterification step and/or prior to or during the polycondensation step in an amount of from 10 to 100% by weight based on the total amount of the provided at least one polyacid and the at least one polyol.

12. A titanate compound in a crystalline form and configured as a heterogeneous catalyst in a polyester polycondensation reaction, wherein the titanate compound is selected from the group consisting of an aluminum titanate compound, a barium titanate compound, a calcium titanate compound, a zinc titanate compound or wherein the titanate compound is a mixture of two, three or four of said titanate compounds.

13. The composition according to claim 7, wherein the aluminum titanate compound, the barium titanate compound, the calcium titanate compound, the zinc titanate compound, or the mixture of the titanate compounds has an average primary particle diameter, measured as defined in the description, in the range of 100 nm to 500 μm, preferably 300 nm to 100 μm, more preferably 400 nm to 50 μm, and most preferably 500 nm to 2000 nm.
